(19) United States
(12) Patent Application Publication
(10) Pub. No.: US 2024/0418216 A1
(43) Pub. Date: Dec. 19, 2024

(54) ANGULAR CONTACT BALL BEARING WITH SPLIT RING

(71) Applicant: Schaeffler Technologies AG & Co. KG, Herzogenauach (DE)

(72) Inventors: Renato de Paula, Sterling Heights, MI (US); Dieter Adler, Herzogenaurach (DE)

(73) Assignee: Schaeffler Technologies AG & Co. KG, Herzogenaurach (DE)

(21) Appl. No.: 18/210,792

(22) Filed: Jun. 16, 2023

(51) Int. Cl. F16C 33/60; F16C 19/16; F16C 33/58

(52) U.S. Cl. CPC F16C 33/605; F16C 19/166; F16C 33/586

(57) ABSTRACT

A bearing assembly includes an inner ring having a radially outer surface with an inner ring groove, a first outer ring portion, a second outer ring portion, a clip and a plurality of ball rollers. The first outer ring portion includes a first radially inner surface, a first end surface, and a first arcuate surface extending between the first radially inner surface and the first end surface. The second outer ring portion includes a second radially inner surface, a second end surface in contact with the first end surface, and a second arcuate surface extending between the second radially inner surface and the second end surface. The clip connects the first outer ring portion and the second outer ring portion, and the plurality of ball rollers are installed in the inner ring groove and contact the first arcuate surface and the second arcuate surface.

### TECHNICAL FIELD

The present disclosure relates generally to an angular contact ball bearing, and more specifically to an angular contact ball bearing with a split ring.

### BACKGROUND

Roller bearings with securing rings are known. One example is shown and described in commonly-assigned U.S. Pat. No. 10,968,952 titled ROLLER BEARING UNIT WITH A SECURING RING, AND METHOD FOR DISASSEMBLING A SECURING RING, to Berthel et al., hereby incorporated by reference as if set forth fully herein.

### SUMMARY

Example aspects broadly comprise a bearing assembly including an inner ring having a radially outer surface with an inner ring groove, a first outer ring portion, a second outer ring portion, a clip and a plurality of ball rollers. The first outer ring portion includes a first radially inner surface, a first end surface, and a first arcuate surface extending between the first radially inner surface and the first end surface. The second outer ring portion includes a second radially inner surface, a second end surface in contact with the first end surface, and a second arcuate surface extending between the second radially inner surface and the second end surface. The clip connects the first outer ring portion and the second outer ring portion, and the plurality of ball rollers are installed in the inner ring groove and contact the first arcuate surface and the second arcuate surface.

In an example embodiment, the first arcuate surface and the second arcuate surface form an outer ring groove. In an example embodiment, the clip is press-fit onto the first outer ring portion and the second outer ring portion. In an example embodiment, the clip maintains an axial position and a radial displacement of the first outer ring portion relative to the second outer ring portion. In an example embodiment, the bearing is a four point ball bearing.

In some example embodiments, the first outer ring portion has a first outer circumferential surface, the second outer ring portion has a second outer circumferential surface, and the clip has an inner circumferential surface in contact with the first outer circumferential surface and the second outer circumferential surface. In some example embodiments, the first outer ring portion has a first notch, and the clip has a first radially inwardly extending ring disposed in the first notch. In an example embodiment, the second outer ring portion has a second notch, and the clip has a second radially inwardly extending ring disposed in the second notch.

In some example embodiments, the clip forms an outermost circumferential surface of the bearing assembly. In an example embodiment, the bearing assembly has a bearing housing. The bearing housing has a bore with an inner circumferential surface, and the clip contacts the inner circumferential surface. In another embodiment, the clip may have a clearance fit to the bearing housing.

Other example aspects broadly comprise a method of manufacturing the bearing assembly. The method includes providing the first outer ring portion, the second outer ring portion, and the clip; connecting the first outer ring portion to the second outer ring portion with the clip; measuring a diameter of a raceway formed by the first arcuate surface and the second arcuate surface; removing the second outer ring portion; selecting a size of the plurality of ball rollers based on the diameter; providing the inner ring; installing the plurality of ball rollers between the inner ring groove and the first arcuate surface; and re-installing the first outer ring portion.

In an example embodiment, the first outer ring portion has a notch or the second outer ring portion comprises a notch, and the method includes forming a portion of the clip into the notch. In an example embodiment, the method includes checking a rotational position of the second outer ring portion relative to the first outer ring portion before the step of removing the second outer ring portion, and positioning the second outer ring portion in the rotational position during the step of re-installing the second outer ring portion.

### BRIEF DESCRIPTION OF THE DRAWINGS

FIG. 1 illustrates a top-half cross-sectional view of a bearing assembly according to an example aspect of the present disclosure.

FIG. 2 illustrates a top-half cross-sectional view of a bearing assembly according to an example aspect of the present disclosure.

FIGS. 3A-3F illustrate various partial cross-sectional views of bearing assemblies installed in bearing housings according to example aspects of the present disclosure.

FIGS. 4A and 4B illustrate schematic steps for manufacturing bearing assemblies according to example aspects of the present disclosure.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

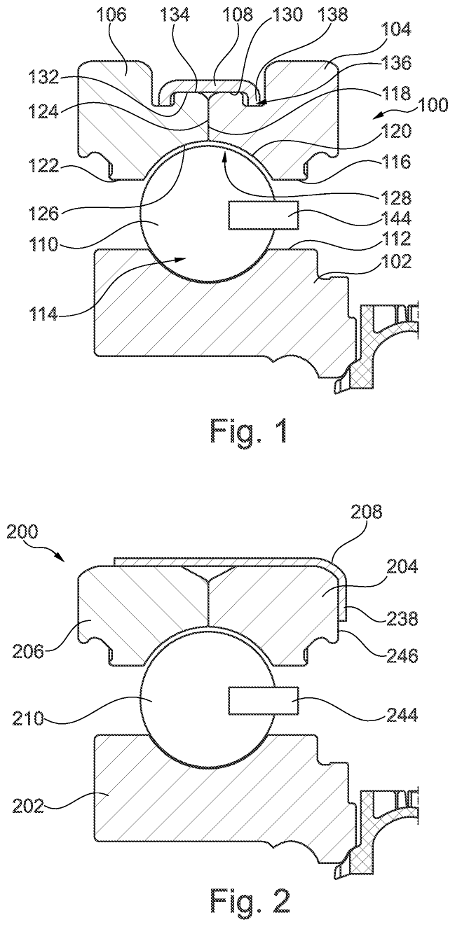

The following description is made with reference to FIG. 1. FIG. 1 illustrates a top-half cross-sectional view of bearing assembly 100 according to an example aspect of the present disclosure. Bearing assembly 100 includes inner ring 102, outer ring portions 104 and 106, clip 108 connecting the outer ring portions, and ball rollers 110. In the embodiment shown, inner ring 102 is integrated into a ball screw nut. Inner ring 102 includes radially outer surface 112 with inner ring groove 114. Outer ring portion 104 includes radially inner surface 116, end surface 118 and arcuate surface 120 extending between radially inner surface 116 and end surface 118. Similarly, outer ring portion 106 includes radially inner surface 122, end surface 124 and arcuate surface 126 extending between radially inner surface 122 and end surface 124. Ball rollers 110 are installed in the inner ring groove and contact arcuate surfaces 120 and 126. That is, arcuate surfaces 120 and 126 form outer ring groove 128, and the ball rollers are installed radially between inner ring groove 114 and outer ring groove 128.

Clip 108 is press-fit onto outer ring portions 104 and 106 to maintain an axial position and a radial displacement of outer ring portion 104 relative to outer ring portion 106. Clip 108 and/or outer ring portions 104 and 106 may include knurling for increased friction between the components. As discussed in more detail below, due to the axial clearance design, the split rings are measured with gauge balls to determine a ball sort vs axial clearance. When re-assembling the split outer ring, portions 104 and 106 are rotationally aligned in a same position as during the measurement to keep a same clearance. Clip 108 maintains the position of the two portions. As shown in FIG. 1, for example, bearing assembly 100 is a four point ball bearing.

Outer ring portion 104 includes outer circumferential surface 130 and outer ring portion 106 includes outer circumferential surface 132. Clip 108 includes inner circumferential surface 134 in contact with outer circumferential surfaces 130 and 132. Outer ring portion 104 includes notch 136 and clip 108 includes radially inwardly extending ring 138 disposed in notch 136. Bearing assembly 100 may also include bearing cage 144 installed to maintain relative circumferential positions of ball rollers 110 after installation.

The following description is made with reference to FIG. 2. FIG. 2 illustrates a top-half cross-sectional view of bearing assembly 200 according to an example aspect of the present disclosure. Configuration of bearing assembly 200 is generally the same as bearing assembly 100 and 2XX reference numbers generally correspond to reference numbers 1XX described above, except as noted below. As shown in FIG. 2, clip 208 forms an outermost circumferential surface of the bearing assembly. That is, clip 208 surrounds at least a portion of radially outer portions 204 and 206. Clip 208 includes radially inwardly extending ring 238 disposed adjacent to annular surface 246 of outer ring portion 204.

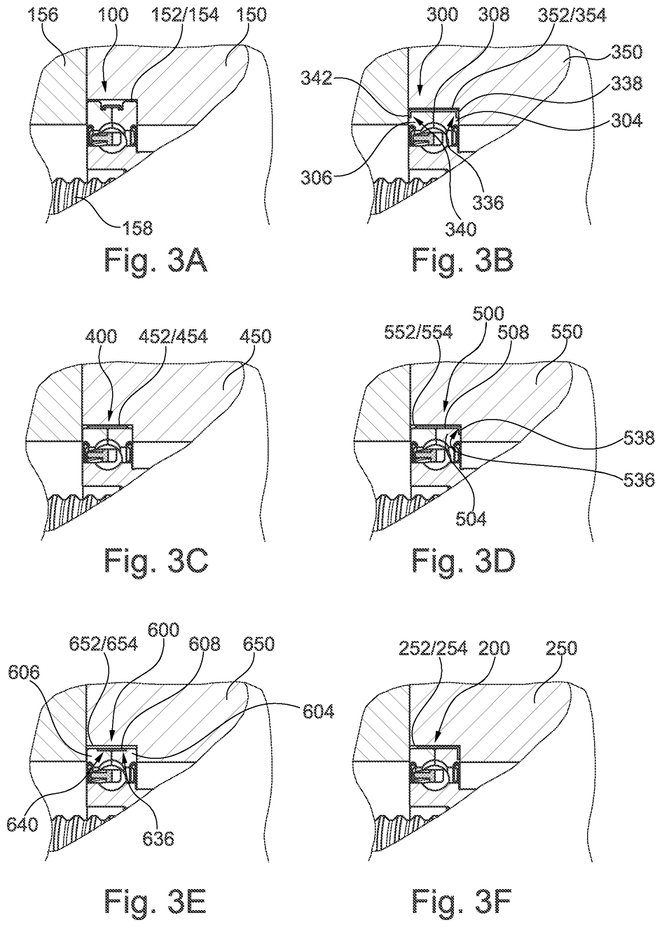

The following description is made with reference to FIGS. 1-3F. FIGS. 3A-3F illustrate various partial cross-sectional views of bearing assemblies installed in bearing housings according to example aspects of the present disclosure. It should be noted that the bearing housing shown is a basic example and other embodiments (not shown) may include an axial wave washer or a lock nut pressing the outer rings together. FIG. 3A illustrates a partial cross-sectional view of bearing assembly 100 described above installed in bearing housing 150. Housing 150 includes bore 152 with inner circumferential surface 154 for receiving the bearing. Component 156 lies adjacent to the housing to axially retain the bearing in the bore. Bearing 100 and housing 150 may be components of a ball screw assembly including ball screw 158, for example.

FIG. 3B illustrates a partial cross-sectional view of bearing assembly 300, similar to bearing assembly 200 described above, installed in bearing housing 350. Bearing assembly 300 differs from bearing assembly 200 in that rings 304 and 306 includes respective notches 336 and 340, and respective radially inwardly extending rings 338 and 342 of clip 308 are installed in the notches. FIG. 3C illustrates a partial cross-sectional view of bearing assembly 400, similar to bearing assembly 200 described above, installed in bearing housing 450. Bearing assembly 400 differs from bearing assembly 200 in that clip 408 is cylindrical in shape without radially inwardly extending ring 238 of clip 208. FIG. 3D illustrates a partial cross-sectional view of bearing assembly 500, similar to bearing assembly 200 described above, installed in bearing housing 550. Bearing assembly 500 differs from bearing assembly 200 in that outer ring portion 504 includes notch 536 for receiving radially inwardly extending ring 538 of clip 508.

FIG. 3E illustrates a partial cross-sectional view of bearing assembly 600, similar to bearing assembly 400 described above, installed in bearing housing 650. Bearing assembly 600 differs from bearing assembly 400 described above in that outer ring portions 604 and 606 include respective notches 636 and 640 for receiving ring 608. FIG. 3F illustrates a partial cross-sectional view of bearing assembly 200, described above, installed in bearing housing 250. As shown in FIGS. 3B-3F, for example, bearing housings 250, 350, 450, 550 and 650 include respective bores 252, 352, 452, 552, and 652 with respective inner circumferential surfaces 254, 354, 454, 554, and 654. Clips 208, 308, 408, 508 and 608 contacts respective inner circumferential surfaces 254, 354, 454, 554, and 654.

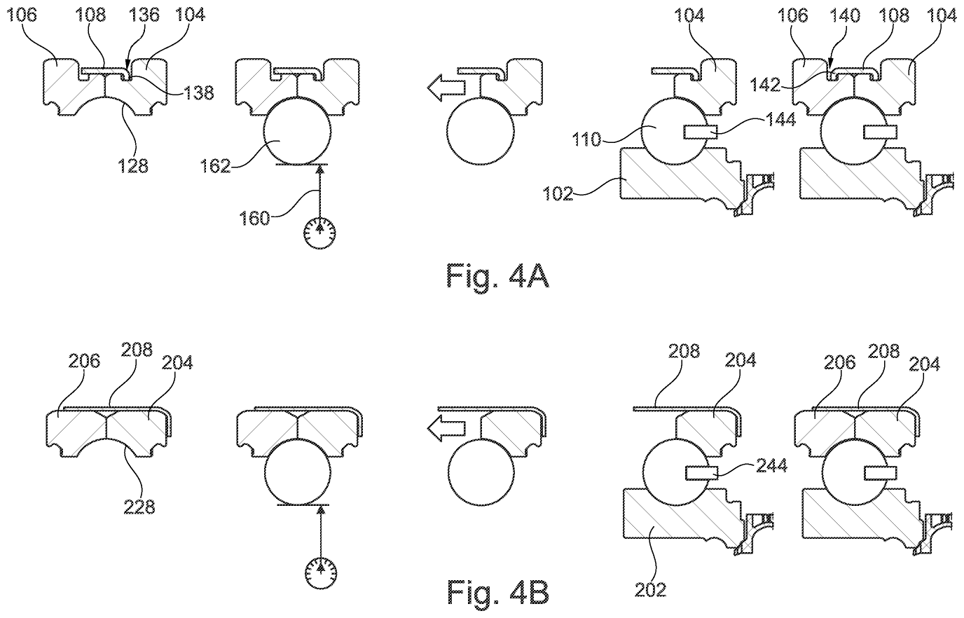

The following description is made with reference to FIG. 4A. FIG. 4A illustrates schematic steps for manufacturing bearing assembly 100. The first image illustrates providing outer ring portions 104 and 106, and clip 108 and connecting outer ring portion 104 to outer ring portion 106 with clip 108. As discussed above, clip 108 has a press-fit so, even though radially inwardly extending ring 242 is not yet formed, the clip will hold the rings together.

The second image illustrates measuring diameter 160 of outer ring groove, or raceway, 128 using gage 162. Once the raceway diameter is determined, appropriately sized ball rollers are sorted and selected based on the measured raceway diameter. The third image illustrates removing outer ring portion 106 so that the selected ball rollers may be inserted. Note that gage 162 is still shown in the third image, but may be removed prior to removing outer ring portion 106. Also, selection of the ball rollers may be performed prior to, during, or after the outer ring portion is removed, for example.

The fourth image shows providing inner ring 102 and ball rollers 110. It should be noted that the ball rollers and inner ring may be preassembled with cage 144 before installation with outer ring portion 104, or the cage may be assembled after outer ring portions 104 and 106 are joined. That is, because the cage holds the ball rollers in position, the inner ring and rollers may be preassembled and measured, and the appropriate ball roller/inner ring assembly may be selected based on the measured outer ring groove diameter. Once the inner ring is provided and the ball rollers are installed between inner ring groove 114 and arcuate surface 120, the fifth image shows that outer ring portion 106 is re-installed to form bearing assembly 100.

As can be seen in the first image, outer ring portion 104 includes notch 136 and clip 108 includes radially inwardly extending ring 138 installed in notch 136. Due to the configuration of notch 136 in outer ring portion 104, ring 138 cannot be pre-formed and must be formed after clip 108 is installed with outer ring portion 104. In other words, an axial end of clip 108 is formed into the notch. Radially inwardly extending ring 138 may be a complete ring or one or more circumferentially spaced tabs bent into the notch. Similarly, once outer ring portion 106 is reassembled, ring 142 (formed as a complete ring or one or more tabs) is pressed into notch 140 to retain ring portion 104 and 106 together. In other words, the method of forming bearing 100 includes forming a portion of clip 108 into one or both of notches 136 and 140.

The method may also include checking a rotational position of outer ring portion 104 relative to outer ring portion 106 before removing outer ring portion 106 and positioning outer ring portion 106 in the rotational position during re-installation of outer ring portion 106. During initial assembly, the rotational position may be marked on the ring, for example, or the respective notches may be located in a particular rotational position and the tabs formed from clip 108 may be used to orient the outer ring portions relative to one another. By maintaining a rotational position of the ring portions, the measured diameter remains more consistent and the ball sort is more effecting, improving operation of the bearing assembly.

The following description is made with reference to FIG. 4B. FIG. 4B illustrates schematic steps for manufacturing bearing assembly 200. The method shown in FIG. 4B is generally the same as in FIG. 4A described above, except that radially inwardly extending ring 238 may be preformed in clip 208 prior to installation with outer ring portion 204, and that outer ring portion 206 is retained entirely by a press-fit of clip 208 without an additional formed inwardly extending ring as discussed above.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### REFERENCE NUMERALS

100 Bearing assembly
102 Inner ring
104 Outer ring portion (first)
106 Outer ring portion (second)
108 Clip
110 Ball rollers
112 Radially outer surface (inner ring)
114 Inner ring groove
116 Radially inner surface (first)
118 End surface (first)
120 Arcuate surface (first)
122 Radially inner surface (second)
124 End surface (second)
126 Arcuate surface (second)
128 Outer ring groove
130 Outer circumferential surface (first)
132 Outer circumferential surface (second)
134 Inner circumferential surface (clip)
136 Notch (first outer ring portion)
138 Radially inwardly extending ring (first)
140 Notch (second outer ring portion)
142 Radially inwardly extending ring (second)
144 Bearing cage
150 Bearing housing
152 Bore (housing)
154 Inner circumferential surface (bore)
156 Component
158 Ball screw
200 Bearing assembly
202 Inner ring
204 Outer ring portion (first)
206 Outer ring portion (second)
208 Clip
210 Ball rollers
238 Radially inwardly extending ring
244 Bearing cage
246 Annular surface (first outer ring portion)
250 Bearing housing
252 Bore (housing)
254 Inner circumferential surface (bore)
300 Bearing assembly
304 Outer ring portion (first)
306 Outer ring portion (second)
308 Clip
336 Notch (first outer ring portion)
338 Radially inwardly extending ring (first)
340 Notch (second outer ring portion)
342 Radially inwardly extending ring (second)
350 Bearing housing
352 Bore (housing)
354 Inner circumferential surface (bore)
400 Bearing assembly
450 Bearing housing
452 Bore (housing)
454 Inner circumferential surface (bore)
500 Bearing assembly
504 Outer ring portion (first)
508 Clip
536 Notch (first outer ring portion)
538 Radially inwardly extending ring (first)
550 Bearing housing
552 Bore (housing)
554 Inner circumferential surface (bore)
600 Bearing assembly
604 Outer ring portion (first)
606 Outer ring portion (second)
608 Clip
636 Notch (first outer ring portion)
638 Radially inwardly extending ring (first)
640 Notch (second outer ring portion)
642 Radially inwardly extending ring (second)
650 Bearing housing
652 Bore (housing)
654 Inner circumferential surface (bore)

What is claimed is:

1. A bearing assembly, comprising:
an inner ring comprising a radially outer surface with an inner ring groove;
a first outer ring portion comprising:
a first radially inner surface;
a first end surface; and
a first arcuate surface extending between the first radially inner surface and the first end surface;
a second outer ring portion comprising:
a second radially inner surface;
a second end surface in contact with the first end surface; and
a second arcuate surface extending between the second radially inner surface and the second end surface;
a clip connecting the first outer ring portion and the second outer ring portion; and
a plurality of ball rollers installed in the inner ring groove and contacting the first arcuate surface and the second arcuate surface.

2. The bearing assembly of claim 1 wherein the first arcuate surface and the second arcuate surface form an outer ring groove.

3. The bearing assembly of claim 1 wherein the clip is press-fit onto the first outer ring portion and the second outer ring portion.

4. The bearing assembly of claim 1 wherein the clip maintains an axial position and a radial displacement of the first outer ring portion relative to the second outer ring portion.

5. The bearing assembly of claim 1 wherein the bearing is a four point ball bearing.

6. The bearing assembly of claim 1 wherein:
the first outer ring portion comprises a first outer circumferential surface;
the second outer ring portion comprises a second outer circumferential surface; and
the clip comprises an inner circumferential surface in contact with the first outer circumferential surface and the second outer circumferential surface.

7. The bearing assembly of claim 6 wherein:
the first outer ring portion comprises a first notch; and
the clip comprises a first radially inwardly extending ring disposed in the first notch.

8. The bearing assembly of claim 7 wherein:
the second outer ring portion comprises a second notch; and
the clip comprises a second radially inwardly extending ring disposed in the second notch.

9. The bearing assembly of claim 1 wherein the clip forms an outermost circumferential surface of the bearing assembly.

10. The bearing assembly of claim 9 further comprising a bearing housing, wherein:
the bearing housing comprises a bore with an inner circumferential surface; and
the clip contacts the inner circumferential surface.

11. A method of manufacturing the bearing assembly of claim 1 comprising:
providing the first outer ring portion, the second outer ring portion, and the clip;
connecting the first outer ring portion to the second outer ring portion with the clip;
measuring a diameter of a raceway formed by the first arcuate surface and the second arcuate surface;
removing the second outer ring portion;
selecting a size of the plurality of ball rollers based on the diameter;
providing the inner ring;
installing the plurality of ball rollers between the inner ring groove and the first arcuate surface; and
re-installing the first outer ring portion.

12. The method of claim 11 wherein:
the first outer ring portion comprises a notch; or
the second outer ring portion comprises a notch; and
the method includes forming a portion of the clip into the notch.

13. The method of claim 11 further comprising:
checking a rotational position of the second outer ring portion relative to the first outer ring portion before the step of removing the second outer ring portion; and
positioning the second outer ring portion in the rotational position during the step of re-installing the second outer ring portion.
